(19) United States
(12) Patent Application Publication
(10) Pub. No.: US 2011/0218831 A1
(43) Pub. Date: Sep. 8, 2011

(54) Informational Kiosk System and Method of Using Same

(76) Inventor: DeAnna Nicole BOLLING, Springfield, MA (US)

(21) Appl. No.: 13/042,447

(22) Filed: Mar. 7, 2011

Related U.S. Application Data
(60) Provisional application No. 61/311,010, filed on Mar. 5, 2010.

(51) Int. Cl. G06Q 10/00; G06Q 30/00

(52) U.S. Cl. 705/5; 705/14.73; 705/14.37

(57) ABSTRACT

An informational kiosk system used to request travel routes and retrieve points of interest. The invention comprises of a kiosk with a central console and an upper display the screen. The central console comprises of a lower display screen used to interact with users through an advanced input system. A user interfaces with an interface software to input requirements for desired points of interest to be transmitted to a central server. Route directions, maps, and coupons are received back from the central server for the user and printed out on a printed map. The interface software comprises of a plurality of interface screens allowing the user to select criteria for points of interest along with routing options.

The current application claims a priority to the U.S. Provisional Patent application Ser. No. 61/311,010 filed on Mar. 5, 2010.

### FIELD OF THE INVENTION

The invention relates generally to an information system used to request travel routes and retrieve points of interest. More specifically, the invention an informational kiosk comprising of interface software for users to input criteria for requested information and a plurality of display screens to output the requested information back to the user. The present invention is used at locations with high traveler or tourist foot traffic such as rest areas, historical sites, attractions, and other points of interest. Users utilize the invention to retrieve information on the location in which the kiosk is positioned or a nearby region within traveling distances.

### BACKGROUND OF THE INVENTION

Traditionally, travelers and tourists rely on maps and printed guides to discover points of interest for a particular destination. When at an unfamiliar location, people have difficulty finding points of interest such as restaurants, lodging, vehicle rental, entertainment, shopping, emergency facilities, etc. Having a guide book for a location will provide information as to the location and quality of points of interest, although not all locations have guide books published. Furthermore, many people do not purchase or bring guidebooks to their destination while still having the need to know about the travel destination. As travel information becomes more readily available on the internet with numerous travel and destination review sites, people are able to find information on almost any destination, big or small. Information provided often comes from reviews by many individuals and reduces biased reviews that may be present in a guide book presented by a single publisher. People with internet enabled devices such as smart phones, personal digital assistants, laptops, or electronic tablets have easy access to travel direction information and locations of points of interest by accessing the information through the internet. However, the majority of the population does not carry around internet enabled portable devices and cannot access the abundance of valuable travel information available through the internet. It is therefore an objective of the present invention to provide destination and travel information to a person by means of a public kiosk system. The public kiosk system interfaces with a user to determine the criteria desired for a point of interest and calculates an optimal travel route to be provided to the user. The kiosk provides desired travel information for the user while providing businesses the opportunity to present advertising to the user. The kiosk finally provides to the kiosk administrators a source of advertising revenue provided by advertising businesses looking to target travelers.

### BRIEF DESCRIPTION OF THE DRAWINGS

FIG. 1 is a perspective view of the present invention.

FIG. 2 is a front view of the present invention.

FIG. 3 is an illustration of an exemplary advertisement display interface.

FIG. 4 is an illustration of an exemplary welcome interface.

FIG. 5 is an illustration of an exemplary select language interface.

FIG. 6 is an illustration of an exemplary select mode of transportation interface.

FIG. 7 is an illustration of an exemplary select route options interface.

FIG. 8 is an illustration of an exemplary select destination type interface.

FIG. 9 is an illustration of an exemplary virtual keyboard.

FIG. 10 is an illustration of an exemplary select location interface.

FIG. 11 is an illustration of an exemplary additional destination interface.

FIG. 12 is an illustration of an exemplary find reverse direction interface.

FIG. 13 is an illustration of an exemplary loading interface.

FIG. 14 is an illustration of an exemplary view map interface.

FIG. 15 is an illustration of an exemplary printed map.

FIG. 16 is an illustration of an exemplary weather report shown on the interface.

FIG. 17 is a flow chart depicting the process of the present invention.

FIG. 18 is a flow diagram showing the flow of information between the servers and the kiosk.

FIG. 19 is a block diagram showing the relationship of the components of the invention to the central console.

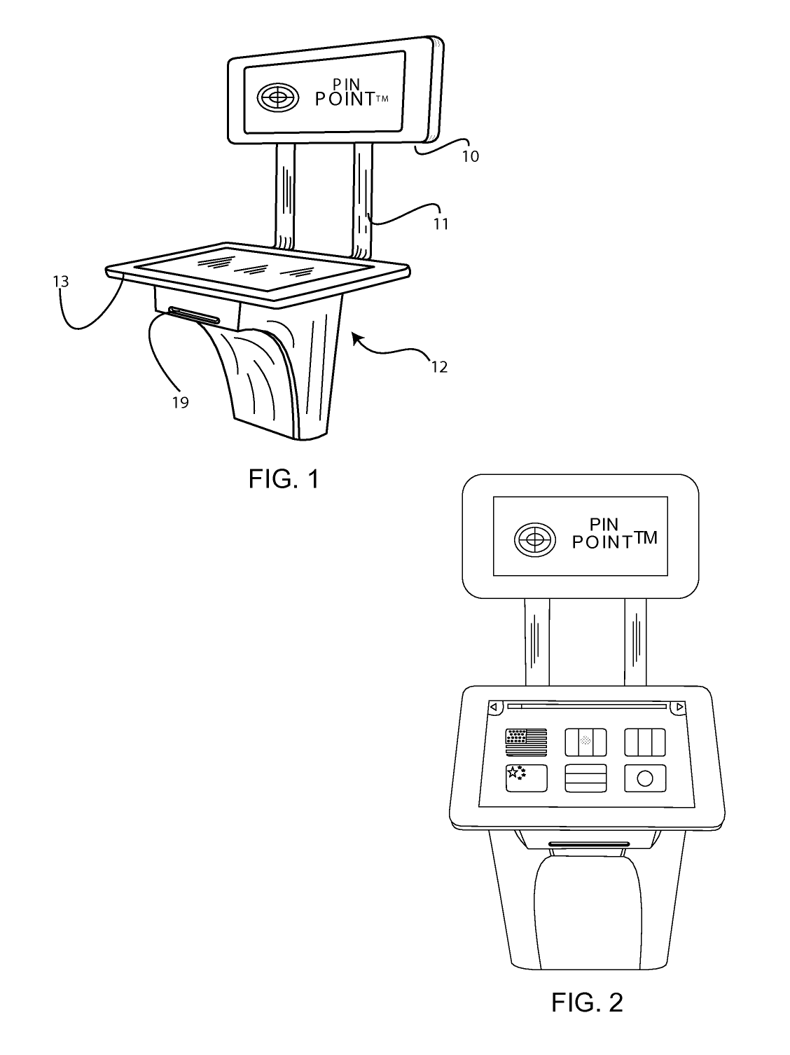

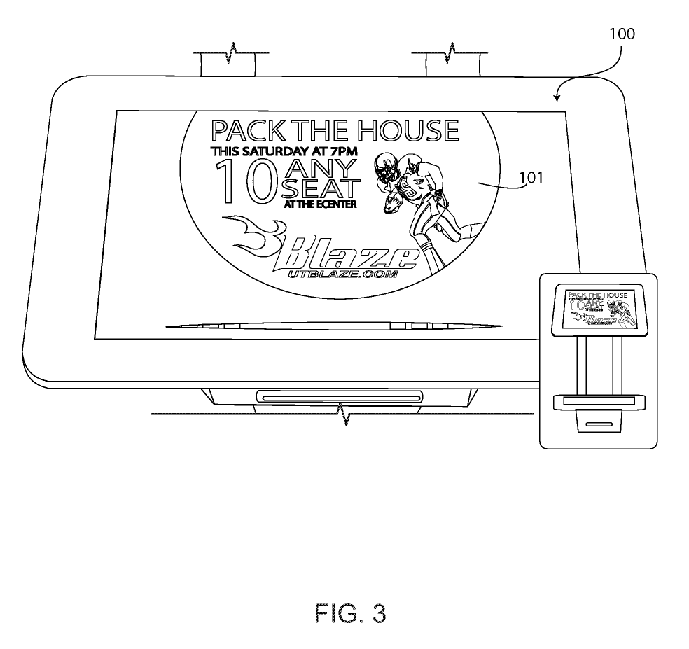

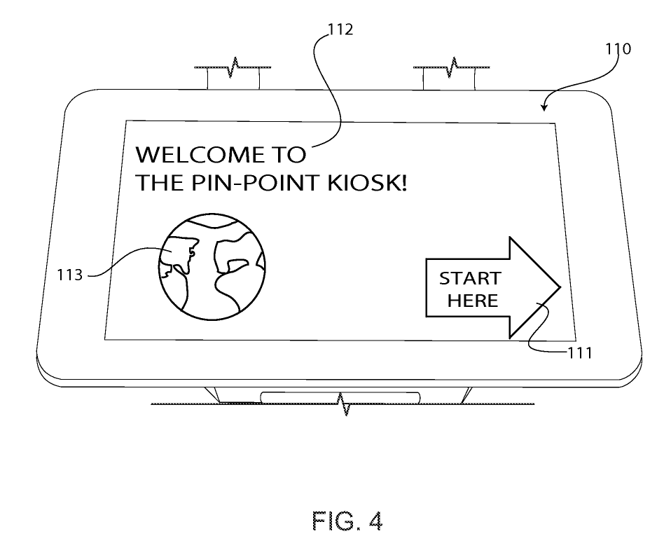

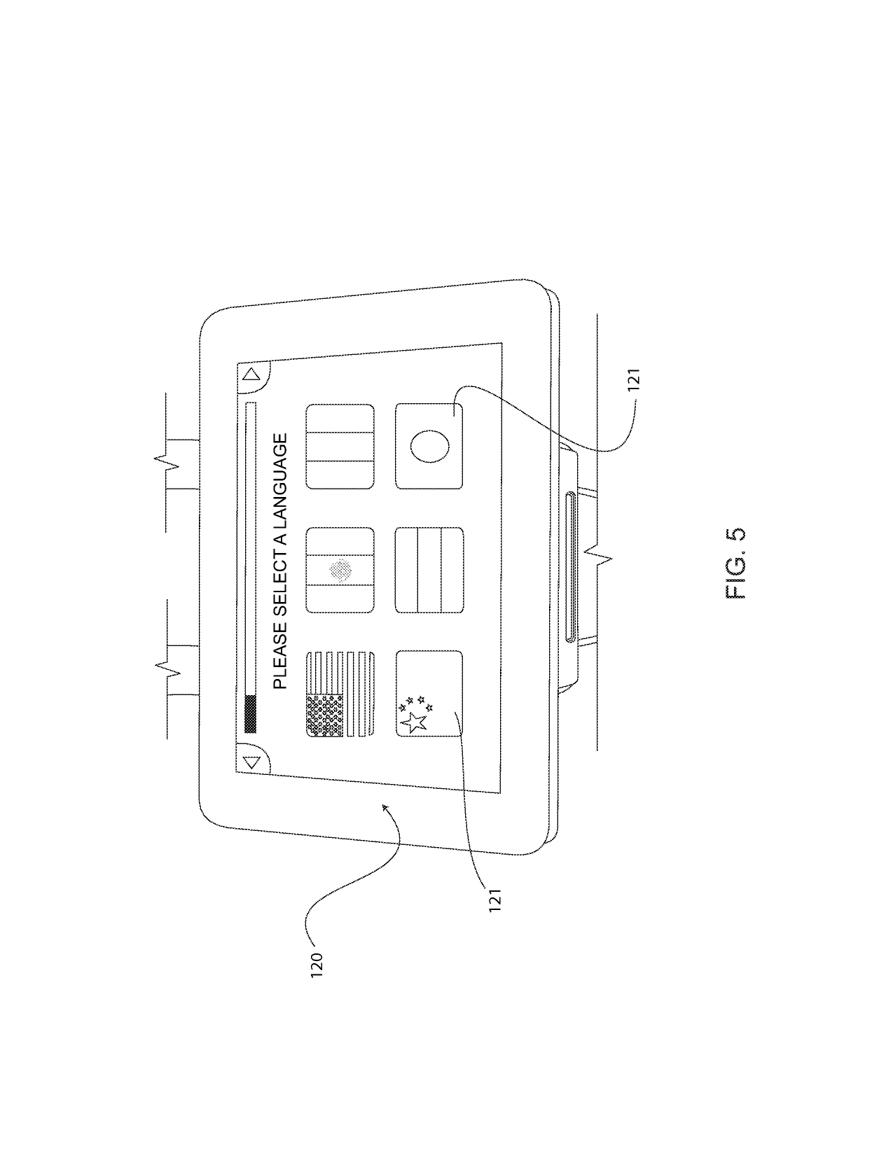

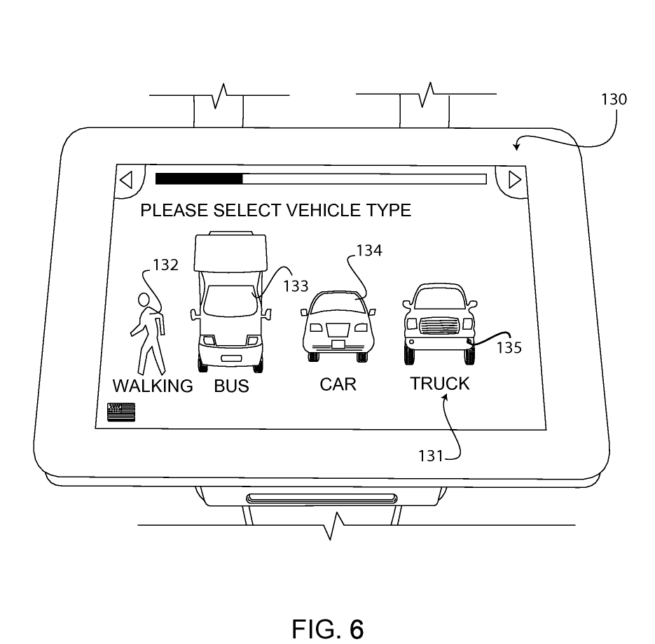

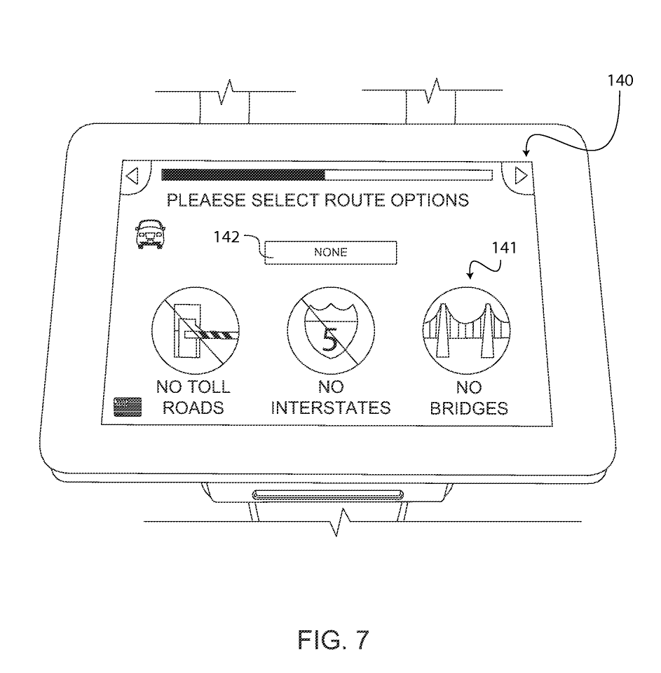

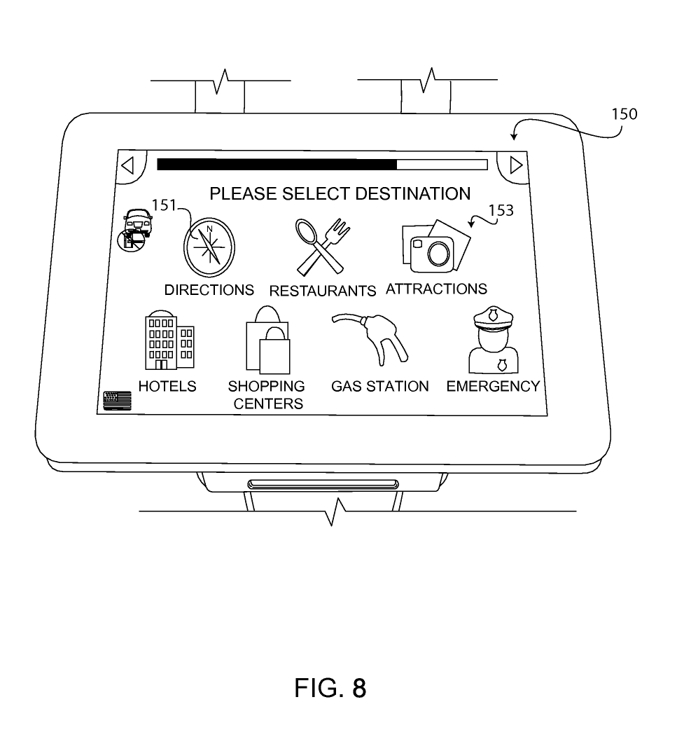

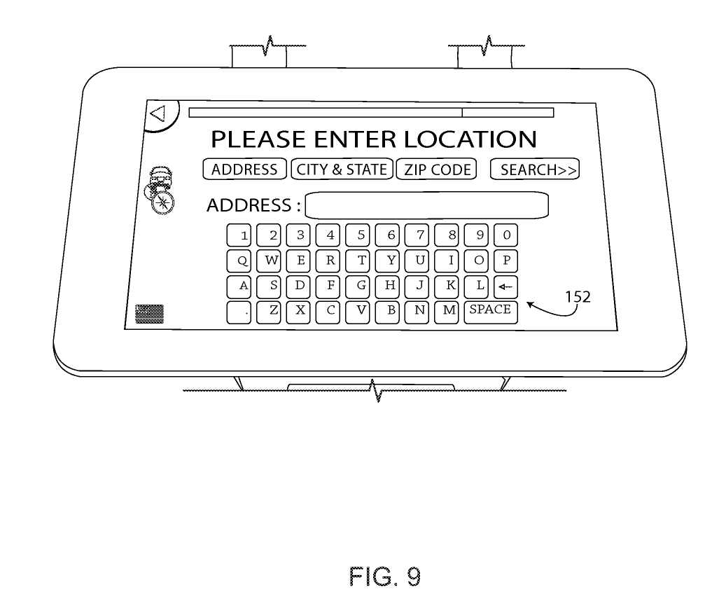

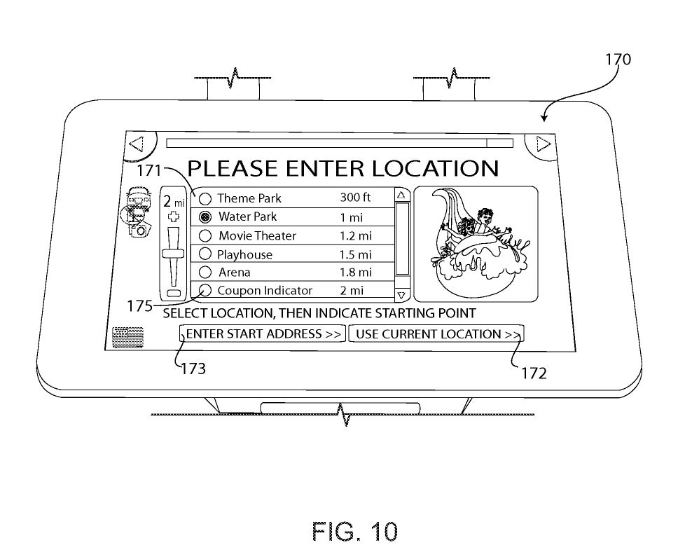

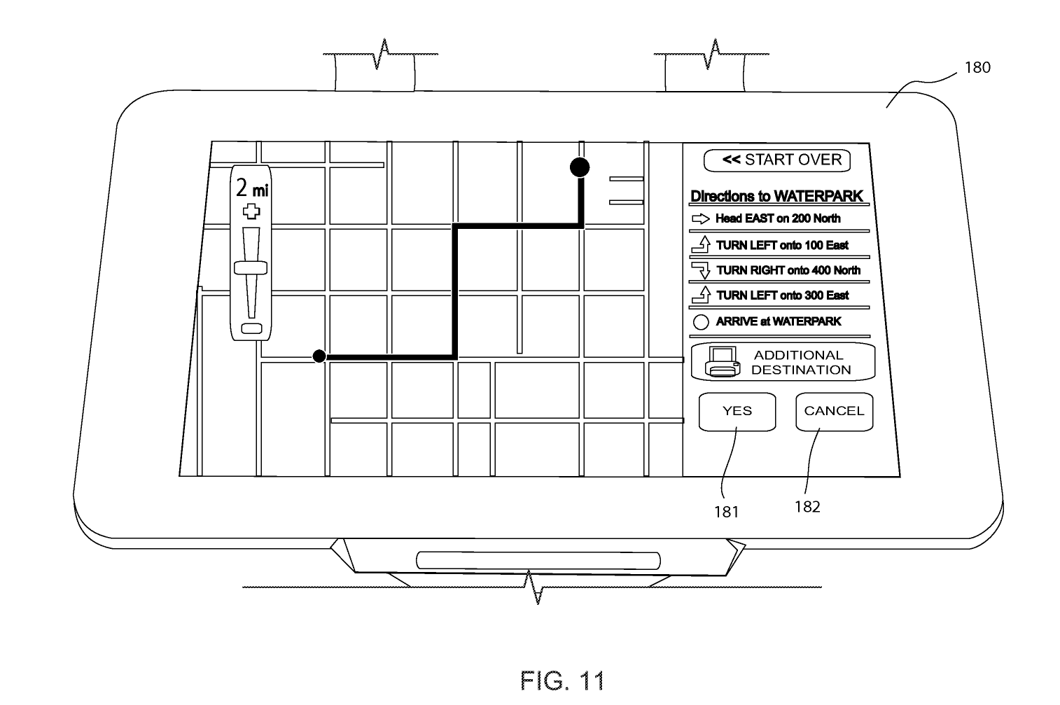

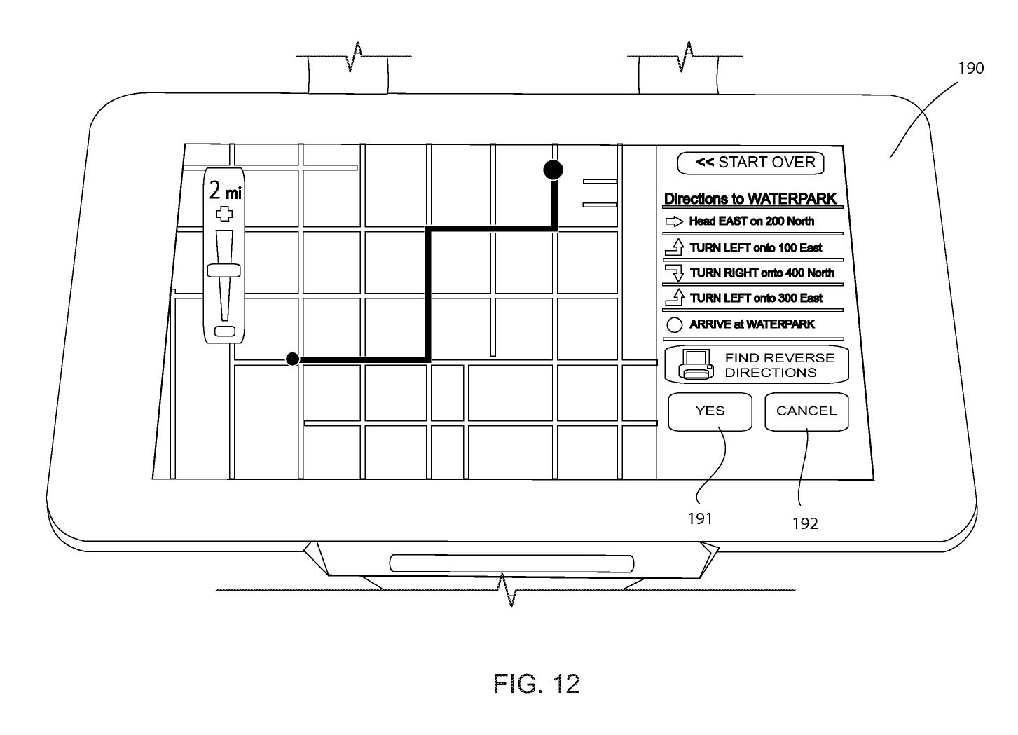

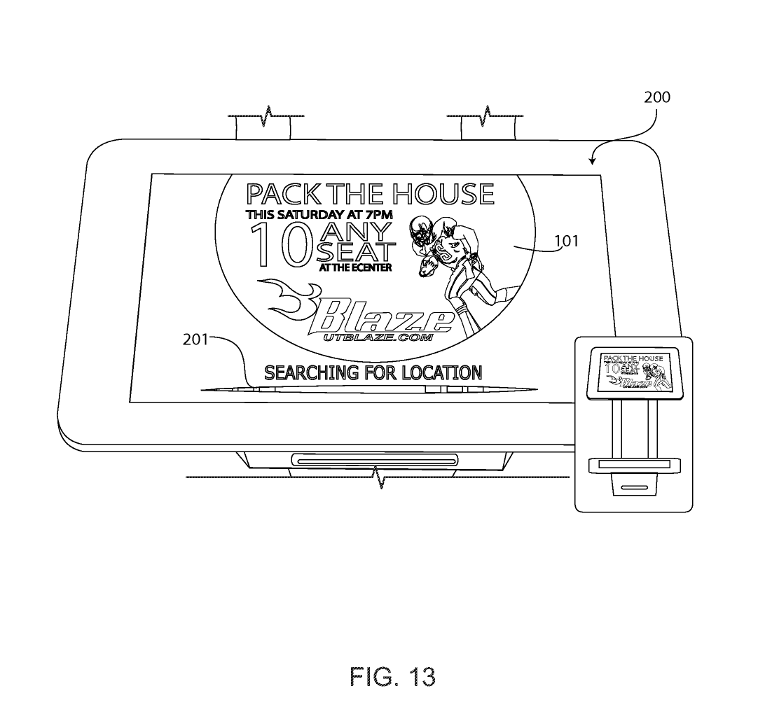

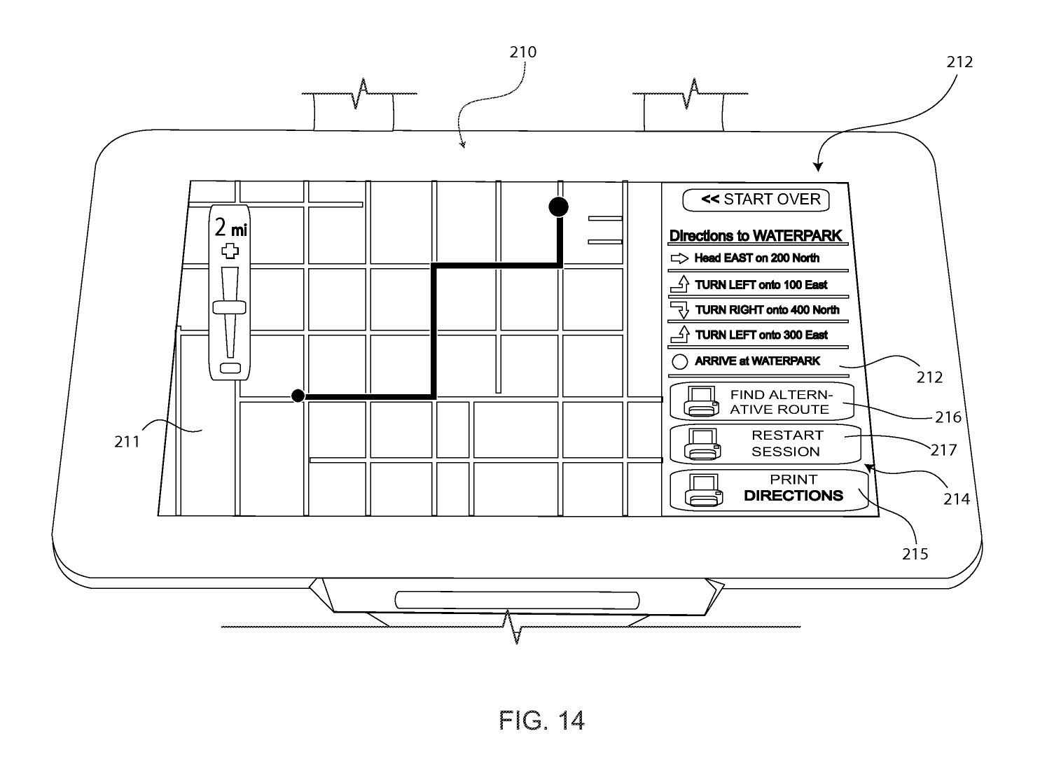

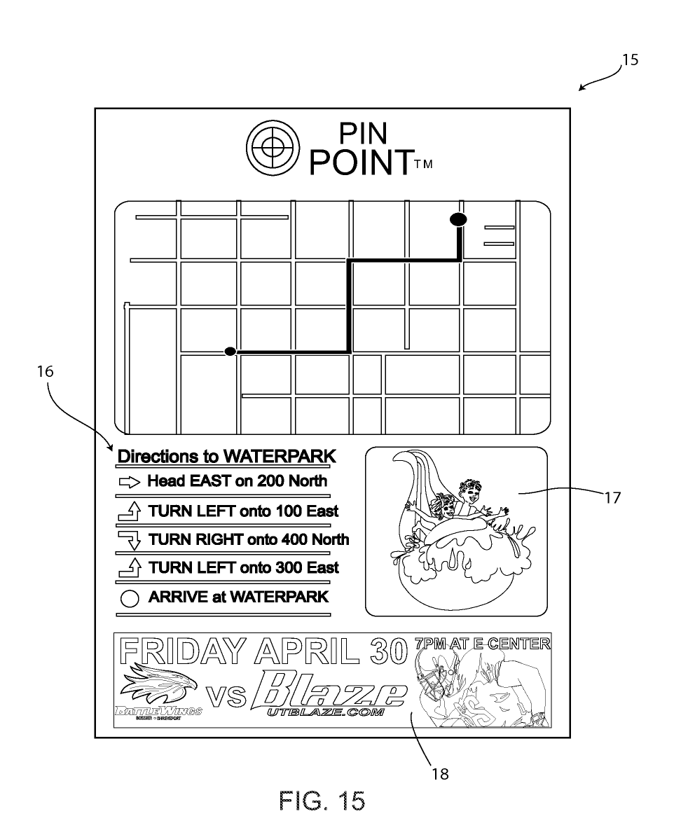

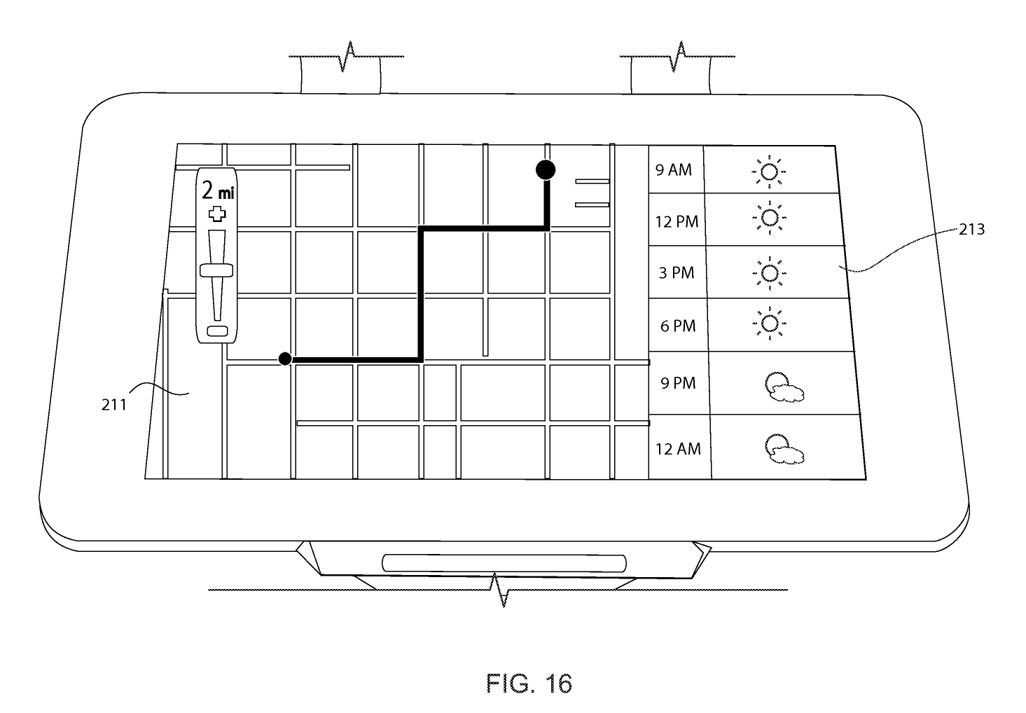

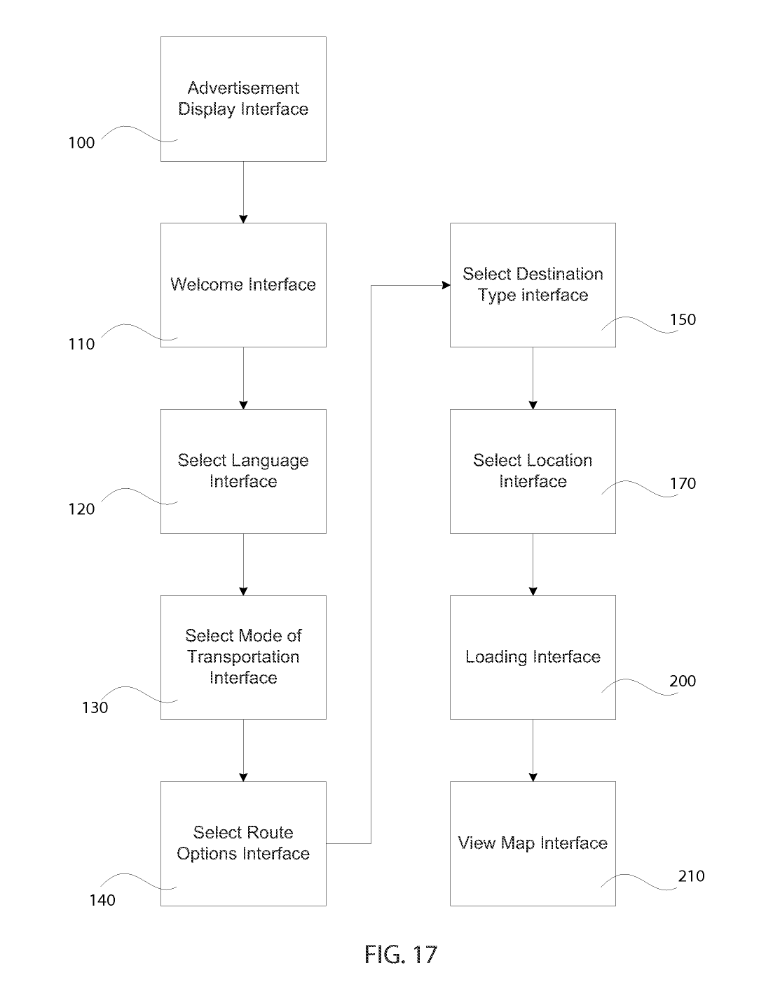

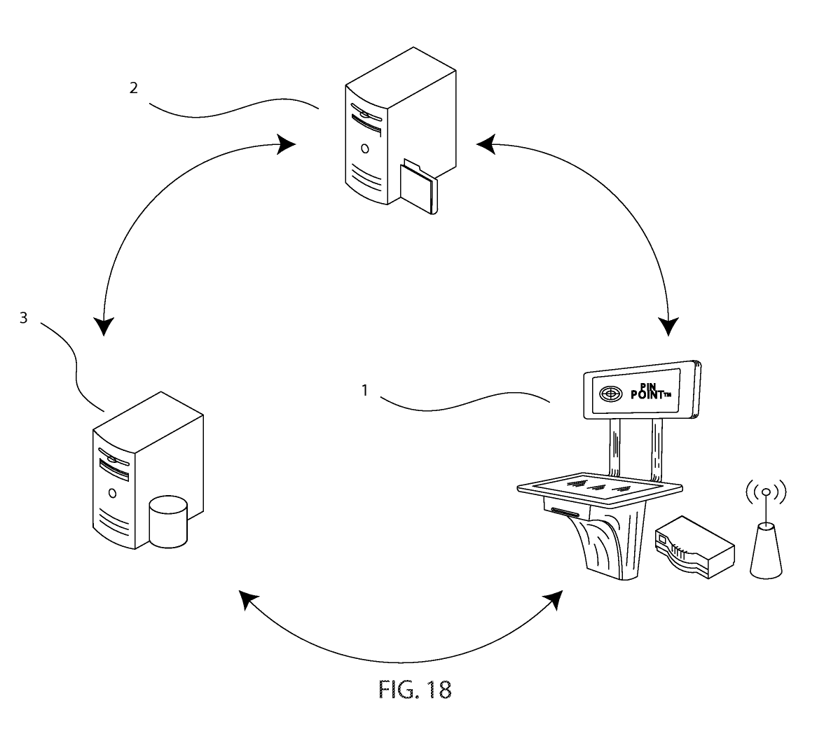

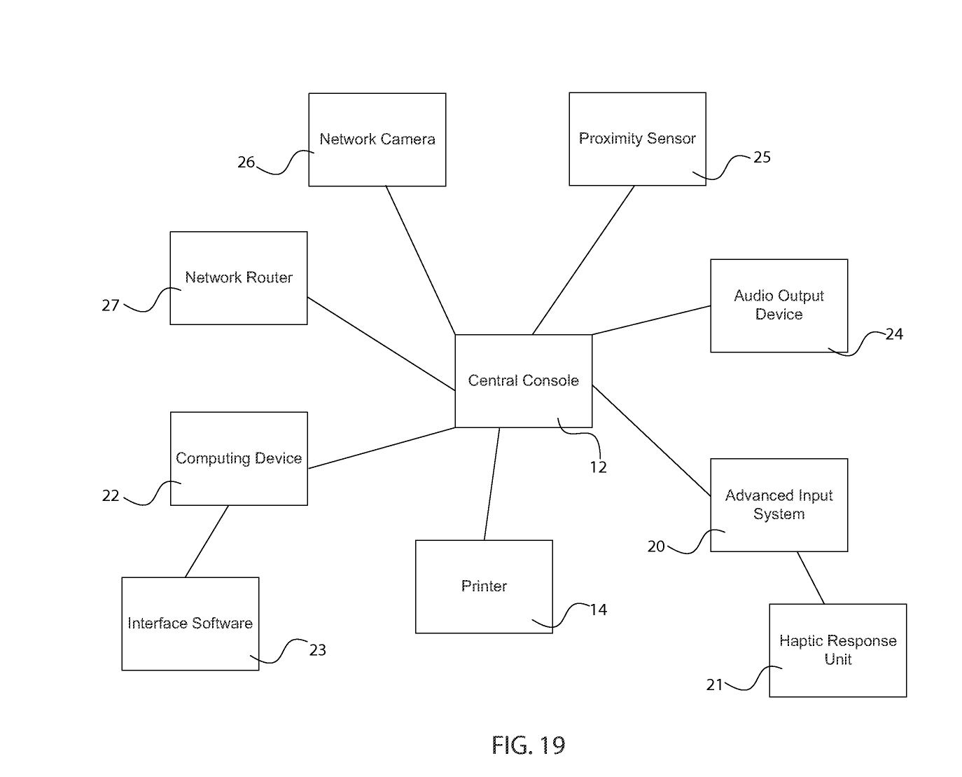

### DETAIL DESCRIPTIONS OF THE INVENTION

All illustrations of the drawings are for the purpose of describing selected versions of the present invention and are not intended to limit the scope of the present invention.

An informational kiosk system comprises of a kiosk 1, a central server 2, and an advertisement server 3. The kiosk 1 is the apparatus of the system in which users physically interact with in order to request and retrieve information provided by the kiosk system. The kiosk 1 comprises of an upper display screen 10, an upper display screen attachment 11, and a central console 12. The upper display screen 10 is attached to the top of the central console 12 by means of the upper display screen attachment 11. The resulting construction is a kiosk 1 in which users may interact with the central console 12 and visual media is additionally displayed overhead the user on the upper display screen attachment 11 to be viewed by people near the kiosk 1 but not directly interfacing with the system.

The central console 12 comprises of a lower display screen 13, a printer 14, a printer 14 slot, an advanced input system 20, a computing device 22, an audio output device 24, a proximity sensor 25, a network camera 26, and a network router 27. The purpose of the central console 12 is to house components which allow the information kiosk system to function and interface with users. The computing device 22 receives input from the kiosk 1, transmits information to and from the central server 2 and the advertisement server 3, and outputs information to the kiosk 1 for the user. The computing device 22 can be selected from any device having a central processing unit such as a personal computer with an operating system to run an interface software 23. The lower display screen 13 is positioned on a surface of the central console 12 facing upward from the ground, allowing users of the kiosk 1 to look down on the lower display screen 13. The lower display screen 13 is connected to the computing device 22 to receive output information to be displayed. The printer 14 is positioned within the central console 12 and connected to the computing device 22 to receive output information to be printed. A printer slot 19 is positioned on a surface of the central console 12 facing towards the user, allowing users of the kiosk 1 to retrieve a printed map 15 from the front of the central console 12. The printer 14 is positioned behind the printer slot 19 and within the central console 12 to allow the printed map 15 to be ejected through the printer slot 19 for retrieval by the user. The printed map 15 comprises of a directions list 16, at least one coupon 17, and at least one advertisement 101 as requested by the user through selections made on the interface software 23. The advanced input system 20 attaches to the lower display screen 13 to allow users to provide input to the system through touching the lower display screen 13. A haptic response unit 21 is connected to the advanced input system 20 to provide haptic response to the user through the lower display screen 13. As a user touches a selection on the lower display screen 13, the advanced input system 20 recognizes the physical contact and the haptic response unit 21 provides a response to the user by vibrating the lower display screen 13. As a result, the user received a tactile response to acknowledge that his or her input has been received by the system. The audio output device 24 is at least one speaker connected to the computing device 22 to receive audio to be outputted and heard by the user. The proximity sensor 25 is positioned on the central console 12 to detect if a user is within usage range of the kiosk 1. When no user is within usage range, the lower display screen 13 presents advertisements. As the proximity sensor 25 detects that a user has approached the kiosk 1 and is within range of use, the lower display screen 13 changes to a welcome interface, allowing the user to begin interfacing with the system. The proximity sensor 25 is connected to the computing device 22 to provide user proximity information to the interface software 23. The network camera 26 is positioned on the kiosk 1 to provide video input to the computing device 22. The network camera 26 may be positioned to retrieve video of the immediate user in front of the kiosk 1 or positioned to retrieve video of the surrounding environment. Video sent to the computing device 22 may be saved to be viewed later or streamed over the internet to kiosk administrators. The network camera 26 may be configured to retrieve video continuously or when activated by the proximity sensor, indicating a user is within usage range of the kiosk 1. The network router 27 is positioned within the central console 12 and connected to the central computing device 22. The network router 27 provides internet connectivity to the computing device 22 by receiving network connectivity from an internet service provider. The internet service provider may be a cable connection, fiber optic connection, cellular data connection or any other suitable means of providing internet connectivity to the network router.

The central server 2 is a data server which is not physically located at the location of the kiosk 1. The central server 2 provides information to and stores information provided by the kiosk 1 which can be accessed by kiosk administrators. The kiosk 1 exchanges data with the central server 2 through a connection provided by the internet. The central server 2 is further connected to the advertisement server 3 wherein the advertisement server 3 is a data server that holds advertisement data. The advertisement server 3 receives updated advertisements and serves them to each kiosk to be displayed by the interface software 23.

The interface software 23 allows the user to interface with the kiosk 1 and comprises of an advertisement display interface, a welcome interface, a select language interface, a select mode of transportation interface 130, a select route options interface 140, a select destination type interface 150, a select location interface 170, an add additional destination interface 180, a get reverse directions interface 190, a loading interface 200, and a view map interface 210.

An advertisement display interface 100 comprises of at least one advertisement 18 wherein the at least one advertisement 18 is retrieved from the advertisement server 3. The advertisement display interface 100 is the default screen that is displayed on the lower display screen 15 when the kiosk 1 is idle and not in use by a user. The at least one advertisement 18 is displayed on the lower display screen 15 and serves as an attention grabber or screen saver, likely to have motion or animations. Advertisements may be in any format such as still image or video format with audio. If audio is present in the advertisement, the kiosk 1 outputs the audio through the audio output device 24, connected to the computing device 22. The advertisement display interface 100 rotates available advertisements provided by the advertisement server 3 on predetermined intervals. Advertisements may be cycled in order at even intervals, cycled randomly, or displayed in variable intervals based on agreement with a particular advertiser. The advertisement display interface 100 is continuously displayed until the kiosk 1 determines a user has approached the kiosk 1 by means of the proximity sensor. When the proximity sensors detects that a user has approached the kiosk 1, the interface software 23 removes the advertisement display interface 100 from the lower display screen and subsequently displays the welcome interface.

The welcome interface 110 comprises of a welcome text 112, a welcome image 112, and a start icon 113. The welcome text 112 is a phrase which welcomes the user who has approached the kiosk 1. The welcome image 113 is an image which welcomes the user who has approached the kiosk 1. A start icon 111 is an icon to be selected by the user by touching the icon and interfacing with the advanced input system 20. As a user presses the start icon 113, the advanced input system 20 recognizes the touch of the user and triggers the haptic response unit 21 to vibrate the lower display screen 15, sending an acknowledgement to the user. Pressing the start icon 111 confirms to the interface software 23 that the user would like to continue to use the kiosk 1 system and the welcome interface 110 is subsequently replaced with the select language interface.

The select language interface 120 comprises of a plurality of country flags 121. The plurality of country flags 121 displays to the user through the lower display screen 15 corresponding languages in which the system supports for displaying text and information to the user. The user is able to select the country flag representing the language in which he or she wants information to be displayed in. Upon selection, the interface software 23 saves the setting for this session and continues to display all subsequent interface information in the language as selected by the user. Once the user has selected their language choice, the selected language will display on the bottom left-hand corner of the screen allowing the user to know what language they have selected for this session. Based on the language selection, all subsequent interface screens are rendered to the selected language. This will enable any user to use the navigational application easily in a language familiar to them. The interface software 23 then removes the select language interface 120 and displays the select mode of transportation interface 130.

The select mode of transportation interface 130 comprises of a plurality of transportation modes 131. The plurality of transportation modes 131 include but are not limited to: a walking option 132, a public transit option 133, a passenger vehicle option 134, and a commercial vehicle option 135. The selection is made by touching a transportation type icon. The user's selection for mode of transportation will be saved for the current user's session and used as a variable when calculating travel directions provided by the kiosk 1. If the user selects the walking option 132, the interface software 23 will provide paths without the busiest roads, freeways, or bridges. As a safety precaution, the application will only allow the end-user to retrieve directions from a thirty mile radius, which will be indicated on the screen as a notification message, along with a safety message to use caution while walking. If the user selects the public transit option 133, the interface software 23 will display a list of additional options including but not limited to, how and when the user would like to leave. For example, the user can chose to leave immediately, or establish a time the user wishes to arrive by or establish a time the user plans to depart at. The user will also have the option to go by the shortest time, to avoid fewer transfers, less street walking, or more street walking. If the user selects their transportation mode as passenger vehicle, the interface software 23 will allow additional options such as but not limited to, avoiding highways, tolls, low underpasses, bridges, seasonal road closures, and turn restrictions. If the user selects the commercial vehicle option, the application will allow the user to select additional options such as but not limited to, avoiding height restrictions, low weight bridges, low underpasses, bridges, seasonal road closures, highways, tolls, and turn restrictions. After a selection is made by the user through the advanced input system 20, the interface system removes the select mode of transportation interface 130 and displays the select route options interface 140.

The select route options interface 140 comprises of a plurality of route options 141 including by not limited to: avoid toll roads, avoid bridges, avoid highways, and a no route preference option 142. The user is able to input through the advanced input system 20 a route preference to be factored in when calculating a route of travel when the user eventually chooses a point of interest for the kiosk 1 to provide directions to. Certain users may wish to avoid toll roads, bridges, highways, or other route preferences. Alternatively, the user may have no preference and can select the no route preference option 142. The selection is saved for the user's session by the interface software 23 and along with all other options and variables, passed to the central server 2 to be used when calculating routes and directions. After the user selects an option on the select route options interface 140, the software interface removes the select route options interface 140 and replaces it with the select destination type interface 150.

The select destination type interface 150 comprises of an input directions option 151 and a plurality of destination types 153. The plurality of destination types may include but are not limited to: a food and drinks option, a travel and accommodations option, an auto and vehicle option, a leisure and entertainment option, a shopping option, a sports option, a services option, an education option, and an emergency and health option. The options are presented as text or with graphical icons to be selected by the user through the advanced input system 20. If the user chooses the input directions option 151, the interface software 23 will display a virtual keyboard 152 so that the user can enter in destination information in the form of an address. If the user knows the destination address, he or she can input the address, city, state, and zip code, which will enable the interface software 23 to use the kiosk's 1 location as the starting point of the user's trip. The entered information is submitted to the central server 2 and processed to determine if the address is valid to be used as a destination. If the user inputs information that is unable to be processed as a valid destination, the system will use search algorithms provide by the central server 2 to determine the most relevant destination based on the user's input. If the most relevant destination as determined by the system is displayed to the user and the user inputs that the destination is incorrect, the virtual keyboard 152 will be displayed so that the user can revise their inputted destination address. Alternatively, if the user selects an option from the plurality of destination types 153, the system will retrieve information relating to the chosen destination type or optionally allow the user to further narrow his or her search with subcategories. If the user selects the food and drinks option, the user is brought to a sub-category list on the lower display interface 15, which will display different types of food and drink related destinations for the user to choose. For example, they will have the ability to choose from but not limited to: restaurants by type, cafes, bars, and other establishments of public catering. If the user selects the travel and accommodation option, the user is displayed a sub-category list on the lower display screen, which will display different type of travel & accommodation related destinations for the user to choose. For example, they will have the ability to choose from but not limited to: hotels, resorts, motels, and apartments. If the user selects the auto and vehicle option, the user will be shown a sub-category list on the lower display screen, which will display different types of auto and vehicle related destinations for the user to choose. For example, they will have the ability to choose from but not limited to: gas stations, car rental places, service stations, part shops, dealerships, car insurance, and DMV's. If the user selects the leisure and entertainment option, the user will be shown a sub-category list on the lower display screen 15 displaying different types of leisure and entertainment related destinations, for the end-user to choose. For example, the user will have the ability to choose from but not limited to: theme parks, water parks, movies, sport stadiums, sport and concert coliseums, museums, zoos, night clubs, and other various leisure & entertainment destinations. If the user selects the shopping option, the user will be displayed a sub-category list on the lower display screen 15, which will display different type of shopping related destinations for the end-user to choose. For example, the user will have the ability to choose from but not limited to: grocery stores, malls, shops, and outlets for food, apparel, and household items. If the user selects the sports option, the user is displayed a sub-category list on the lower display screen 15, which will display different type of sport related destinations, for the end-user to choose. For example, users have the ability to choose from but not limited to: sports and fitness centers or clubs, and public swimming pool locations. If the user chooses to select the services option, the user will be brought to a sub-category list on the lower display screen 15, which will display different types of service related destinations for the end-user to choose. For example, the user will have the ability to choose from but not limited to: personal services, home services, or animal services. If the user chooses to select the education option, the user will be brought to a sub-category list on the lower display screen 15, which will display different type of educational related destinations for the end-user to choose. For example, the user will have the ability to choose from but not limited to: K-12 schools, community colleges, college universities, and driving schools. If the user selects the emergency and health option, the user will be brought to a sub-category list on the lower display screen 15, which will display different types of emergency and health related destinations for the end-user to choose. For example, the user will have the ability to choose from but not limited to: hospitals, medical clinics, medical facilities, or pharmacies. Once the user has selected the destination type, the selections are saved and passed to the central server 2 to retrieve relevant points of interest that are within a predetermined distance from the physical kiosk location. Subsequently, the interface software 23 displays the select location interface 170.

The select location interface 170 comprises of a list of points of interest 171, a use current location option 172, a select starting point option 173, and a coupon indicator 175. The list of points of interest 171 itemizes points of interest retrieved from the central server 2 which are in the category as selected by the user in the select destination type interface 150. Users browse through the list of points of interest 171 and can read information about each point of interest, its location, and any associated media content. The select location interface 170 creates the ability for the user to select from a list of their wanted points of interest up to a specific mile radius from the physical location of the kiosk 1. The selection can be made by touching an image icon of one of the locations. Once a point of interest has been chosen, the user will have the option to use the current location of the kiosk 1, or they will have the option to enter in a start pointing using the virtual keyboard 152. Current location data is determined by invoking a special location providing web service or as pre-programmed into the kiosk 1 system. Alternatively, the kiosk 1 system can internally determine the current location and will use it to query direction and map information. Among information provided, reviews may be retrieved and displayed for the points of interest that are presented on the list of points of interest 171. The coupon indicator 175 is present and displayed alongside of a specific point of interest if a coupon is available for that specific point of interest. The coupon indicator 175 indicates to the user that a coupon is available and will be printed along with travel directions if the particular point of interest is selected by the user. Once the user has selected a point of interest from the list of points of interest 171, the software interface displays the add additional destination interface 180.

The add additional destination interface 180 comprises of an option to add additional destination 181 and an option to not add additional destination 182. Selecting the option to add additional destination 181 will result in the software interface to again load the select destination type interface 150. This allows the user to select an additional destination type and subsequently select an additional point of interest from the list of points of interest 171. The selected additional point of interest will be used along with the first selected point of interest to ultimately generate travel routes. Selection of additional points of interests can be repeated until the user has selected the total amount of points of interest in which he or she would like to add to the trip. The cumulative information selected is saved for the session to be later used in travel route calculation. If the user selects the option to not add additional destination 182, the software interface will transition to the get reverse directions interface 190.

The get reverse directions interface 190 comprises of an option to get reverse directions 191 and an option to not get reverse directions 192. If the user selects the option to get reverse directions 191, the interface software 23 will record this setting for the session and at the end of the session, provide travel route information to the user which routes a path from the starting point to the one or more points of interest along with reverse directions from the final destination point of interest back to the starting point. If the user selects the option to not get reverse directions 192, this setting is recorded for the session and at the end of the session, reverse directions will not be provided to the user. After a selection has been made by the user using the get reverse directions interface 190, the interface software 23 then transitions to the loading interface 200.

The loading interface 200 comprises of a loading indicator 201 and at least one advertisement 18. The loading indicator 201 is a graphical animation which displays to the user that the kiosk 1 system is computing and processing data to provide the requested travel information to the user. When the user has interfaced with the software interface to this point, all of the selected options have been stored temporarily for the user of the active session. At the loading interface 200, selected options are submitted to the central server 2 to be processed. The central server 2 uses any available means and resources to output information including but not limited to: directions list to the at least one destination, visual map, weather information at destination, and any other information relevant to a particular destination. While the data is being gathered and processed, the user sees the loading interface 200 on the lower display screen which shows the loading indicator 201, allowing the user to know that the information requested is being loaded. Furthermore, the at least one advertisement 18 is displayed for the user to view while waiting for the requested information. By providing the at least one advertisement 18 while the user waits, the kiosk 1 administrators may generate advertising revenue. Advertisers would be able to target travelers aiming to go to a particular destination. Content to be displayed by the at least one advertisement 18 is retrieved from the advertisement server 3. When a predetermined time has elapsed or the at least one advertisement 18 has ended, the interface software 23 transitions to the view map interface 210.

The view map interface 210 comprises of a map, a direction list 212, a weather report 213, and a set of map options 214. The map is an interactive virtual map where the route in which the kiosk 1 system has determined to be the most optimal route, based on the user's selections in preceding steps, is displayed. The map may include interactive options such as the ability to zoom-in, zoom-out, display traffic, and hide traffic. The direction list 212 orders the turn-by-turn directions for the user to reach the at least one points of interest. The weather report 213 shows the current temperature and weather conditions at the at least one points of interest. A set of map options 214 comprise of an option to print directions 215, an option to find an alternative route 216, and an option to re-start session 217. The option to print directions 215 triggers the printer 14 to print the printed map 15 to be retrieved from the printer 14 slot of the kiosk 1. The printed map 15 will include the directions list 16, the at least one coupon 17, and the at least one advertisement 18. The at least one coupon 17 is printed if available from the point of interest. The at least one advertisement 18 is printed to allow the kiosk 1 administrators to generate advertisement revenue as each user of the kiosk 1 who prints travel directions will see the advertisement next to the information they have requested. If the user selects the option to find an alternative route 216, the user will be directed back to the loading interface 200 while an alternate route is found. When the alternate route is found, the user is displayed the view map interface 210 again using the alternate route. If the user selects the option to re-start session 217, the interface software 23 displays the select mode of transportation interface 130 and all previous selected options and entries are cleared from memory to allow a new set of selections and options by the user.

After the end-user has selected the option to print directions 215, the user will be voice prompted indicating that their directions are printing. Details of the printed map 15 include a directions list 16, at least one coupon 17, at least one advertisement 18, and optional reverse directions. The at least one coupon 17 is available if only the selected location or locations have decided to advertise on the kiosk 1. Along with that, the end-user will see the at least one advertisement 18 at the top or bottom of the printed map 15.

After the kiosk 1 system has successfully printed the printed map 15 the interface system resets back to the advertisement display interface. Once the proximity sensor 25 detects that the user has departed the kiosk 1, it is fully reset to its original idle position. When the proximity sensor 25 detects a new user has approached the kiosk 1, the interface software 23 will transition to the welcome interface 110 and the kiosk 1 can be used again by the new user.

The upper display screen 10 displays advertisements or eye catching media for viewing by people within viewing distance of the kiosk 1 but not within usage distance of the kiosk. The objective of the upper display screen 10 is to draw attention to the kiosk and encourage people nearby to stop and utilize the kiosk system. Advertisements may be displayed on the upper display screen 10 to generate advertising revenue for the kiosk administrators.

In a preferred embodiment, data used to provide points of interest information, calculated route results, and all other data is injected to the computing device 22 by invoking a web service provided by the central server 2 or the advertising server 3. Silverlight technology by Microsoft is used to create the interface software although other suitable means of developing the interface software 23 may be utilized. An API call is invoked by the interface software 23 to retrieve data from the central server 2 or the advertising server 3.

Although the invention has been explained in relation to its preferred embodiment, it is to be understood that many other possible modifications and variations can be made without departing from the spirit and scope of the invention as hereinafter claimed.

What is claimed is:

1. An information kiosk system comprises of:
a kiosk;
a central server;
an advertisement server;
the kiosk comprises of an upper display screen, an upper display screen attachment, and a central console;
the central console comprises of a lower display screen, a printer, a printer slot, an advanced input system, a computing device, an audio output device, a proximity sensor, a network camera, and a network router;
the upper display screen attaches to the central console by means of the upper display screen attachment to prop the upper display screen above the central console;
the computing device is positioned inside the central console;
the lower display screen is fixed to a surface of the central console and connects to the computing device;
the printer slot is positioned to a second surface of the central console; and
the printer is positioned inside the central console and connects to the computing device.

2. The information kiosk system as claimed in claim 1 comprises of:
the printer comprises of a printed map wherein the printed map comprises of a directions list, at least one coupon, and at least one advertisement;
the printer is aligned with the printer slot allowing the printed map to exit the central console by means of the printer slot;
the computing device comprises of an interface software to interface with a user;
the advanced input system comprises of a haptic response unit wherein the haptic response unit sends vibrations to the user through means of the lower display screen to acknowledge execution of a command.
the audio output device being positioned inside the central console and connects to the computing device;
the proximity sensor being positioned inside the central console and connects to the computing device;
the network camera being positioned inside the central console and connects to the computing device; and
the network router being positioned inside the central console and connects to the computing device.

3. The information kiosk system as claimed in claim 1 comprises of:
the kiosk being connected to the central server and the advertisement server by means of the network router through an internet connection.

4. An information kiosk system comprises of:
a kiosk;
a central server;
an advertisement server;
the kiosk comprises of an upper display screen, an upper display screen attachment, and a central console;
the central console comprises of a lower display screen, a printer, a printer slot, an advanced input system, a computing device, an audio output device, a proximity sensor, a network camera, and a network router;
the upper display screen attaches to the central console by means of the upper display screen attachment to prop the upper display screen above the central console;
the computing device is positioned inside the central console;
the lower display screen is fixed to a surface of the central console and connects to the computing device;
the printer slot is positioned to a second surface of the central console;
the printer is positioned inside the central console and connects to the computing device;
the printer comprises of a printed map wherein the printed map comprises of a directions list, at least one coupon, and at least one advertisement;
the computing device comprises of an interface software to interface with a user; and
the advanced input system comprises of a haptic response unit wherein the haptic response unit sends vibrations to the user through means of the lower display screen to acknowledge execution of a command.

5. The information kiosk system as claimed in claim 4 comprises of:
the printer is aligned with the printer slot allowing the printed map to exit the central console by means of the printer slot;
the audio output device being positioned inside the central console and connects to the computing device;
the proximity sensor being positioned inside the central console and connects to the computing device;
the network camera being positioned inside the central console and connects to the computing device;
the network router being positioned inside the central console and connects to the computing device; and
the kiosk being connected to the central server and the advertisement server by means of the network router through an internet connection.

6. A method of providing an interface software comprises of:
providing a lower display screen wherein the lower display screen displays an advertisement display interface;
detecting a moving motion by a proximity sensor wherein the proximity sensor activates a display of a welcome interface by the display screen;
the displaying of the welcome interface provides a start icon, a welcome text, and a welcome image; and
selecting of the start icon through an advanced input interface.

7. The method of providing an interface software as claimed in claim 6 comprises of:
in response of selecting of the start icon, displaying a select language interface wherein the select language interface displays a plurality country flags;
selecting of the plurality of country flags through an advanced input interface;
in response of selecting of the plurality of country flags, displaying a select mode of transportation interface wherein the select mode of transportation interface displays a plurality of transportation modes;
selecting of the plurality of transportation modes through an advanced input interface;

8. The method of providing an interface software as claimed in claim 7 comprises of:
in response of selecting of the plurality of transportation modes, displaying a select route options interface wherein the select route options interface displays a plurality of route options and a no route preference option; and
selecting of the plurality of route options or a no route preference option through an advanced input interface.

9. The method of providing an interface software as claimed in claim 8 comprises of:
in response of selecting of the plurality of route options or a no route preference option, displaying a select destination type interface wherein the select destination type interface displays an input directions option and a plurality of destination types; and
selecting of the input directions option or the plurality of destination types through an advanced input interface.

10. The method of providing an interface software as claimed in claim 9 comprises of:
in response of selecting of the input directions option or the plurality of destination types, displaying a select location interface wherein the select location interface displays a list of points of interest, a use current location option, a select starting point option, and a coupon indicator; and
selecting of the list of points of interest and either the use current location option or the select starting point option through an advanced input interface.

11. The method of providing an interface software as claimed in claim 10 comprises of:
in response of selecting the list of points of interest and either the use current location option or the select starting point option, displaying a add additional destination interface wherein the add additional destination interface displays an option to add additional destination and an option to not add additional destination; and
selecting of the option to add additional destination or the option to not add additional destination through an advanced input interface.

12. The method of providing an interface software as claimed in claim 11 comprises of:
in response of selecting the option to add additional destination or the option to not add additional destination, displaying a get reverse directions interface wherein the get reverse directions interface displays an option to get reverse directions and an option to not get reverse directions; and
selecting of the option to get reverse directions or the option to not get reverse directions through an advanced input interface.

13. The method of providing an interface software as claimed in claim 12 comprises of:
in response of selecting the option to get reverse directions or the option to not get reverse directions, displaying a loading interface wherein the loading interface displays a loading indicator and at least one advertisement;
in response of displaying the loading indicator and the at least one advertisement, displaying a view map interface wherein the view map interface comprises of a map, a direction list, a weather report, and a set of map options; and
the displaying of the set of map options provides an option to print directions, an option to find an alternative route, and an option to re-start session.

14. The method of providing an interface software as claimed in claim 7 comprises of:
providing the plurality of transportation modes wherein the plurality of transportation modes offers a walking option, a public transit option, a passenger vehicle option, and a commercial vehicle option.

15. A method of providing an interface software as claimed in claim 13 comprises of:
storing the plurality of options selected in a computing device;
transmitting the plurality of options selected to the central server;
receiving a set of data from the central server where the set of data is processed by the computing device and displayed on the select location interface and the view map interface;
receiving at least one advertisement from an advertisement server wherein the at least one advertisement is displayed on the advertisement display interface, the loading interface, and the printed map;
in response of selecting the input directions option, displaying a virtual keyboard;
in response of selecting a select starting point option, displaying the virtual keyboard; and
storing an address entered by the virtual keyboard in the computing device and transmitting the address to the central server.

16. A method of providing an interface software as claimed in claim 13 comprises of:
in response of selecting the option to print directions, printing a printed map;
in response of selecting the option to find an alternative route, displaying the loading interface and transmitting the plurality of options selected to the central server; and
in response of selecting the option to re-start session, displaying the select mode of transportation interface.
